(19) United States
(12) Patent Application Publication
(10) Pub. No.: US 2024/0210885 A1
(43) Pub. Date: Jun. 27, 2024

(54) PROTECTIVE CASING FOR WATCH

(71) Applicant: Omega SA, Biel/Bienne (CH)

(72) Inventor: Antoine UMMEL, Neuchãtel (CH)

(73) Assignee: Omega SA, Biel/Bienne (CH)

(21) Appl. No.: 18/538,045

(22) Filed: Dec. 13, 2023

(30) Foreign Application Priority Data
Dec. 23, 2022 (EP) 22216516.9

(51) Int. Cl. G04B 37/00; G02F 1/13357

(52) U.S. Cl. CPC G04B 37/005; G02F 1/1336

(57) ABSTRACT

A Dewar casing (1) for mechanical and/or functional components (5) of a watch (10), provided with an enclosure (4) wherein a case (12) of the watch (10) can be removably arranged, a display interface of which is disposed facing a crystal (6) of the casing (1), the casing (1) including a reversible fixing device (13) fixing the watch (10) case (12) in the enclosure (4) while keeping it away from functional elements (15) forming the enclosure (4) of this case (2), the crystal (6) of the casing (1) including an element for varying the transmittance (7a) of the crystal (6) and an element for generating illumination (7b) directed towards a display interface of the watch (10).

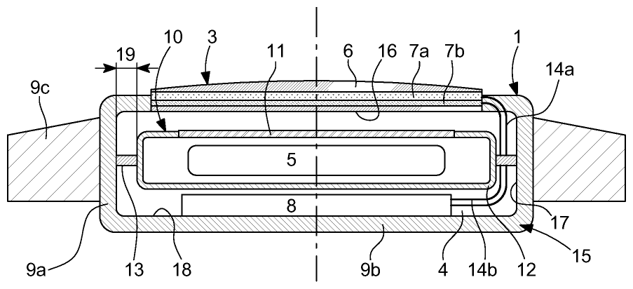

### CROSS REFERENCE TO RELATED APPLICATION

This application claims priority to European Patent Application No. 22216516.9 filed Dec. 23, 2022, the entire contents of which are incorporated herein by reference.

### TECHNICAL FIELD OF THE INVENTION

The invention relates to a protective casing for a watch of the Dewar casing type, in particular thermally protecting mechanical and/or functional components of a watch arranged in said casing.

### TECHNOLOGICAL BACKGROUND

A watch conventionally comprises a bracelet and a watch case including several mechanical, electrical or electronic components. It is known in the prior art that some of these components cannot withstand certain temperatures, and cease to operate correctly at these temperatures.

There is therefore a need to be able to use a watch, particularly an electronic watch, in environments where such temperatures may prevail.

### SUMMARY OF THE INVENTION

To this end, the invention relates to a Dewar casing for mechanical and/or functional components of a watch, provided with an enclosure wherein a case of said watch can be removably arranged, a display interface of which is disposed facing a crystal of said casing, said casing comprising a reversible fixing device fixing said watch case in said enclosure while keeping it away from functional elements forming said enclosure of this casing, the crystal of said casing comprising an element for varying the transmittance of said crystal and an element for generating illumination directed towards a display interface of said watch.

In other embodiments:
the element for varying the transmittance and the element for generating illumination are comprised in said crystal (6) and are superimposed;
the crystal is formed by an assembly comprising successively a layer of transparent material, a stack of functional layers forming said transmittance variation element and a stack of functional layers forming said illumination generation element;
the crystal is formed by an assembly comprising successively an outer layer of transparent material, a stack of functional layers forming said transmittance variation element, a stack of functional layers forming said illumination generation element and an inner layer of transparent material;
the crystal is formed by an assembly comprising successively a first outer layer of transparent material, a stack of functional layers forming said transmittance variation element, a second outer inner layer of transparent material and a stack of functional layers forming said illumination generation element;
the casing comprises a control unit connected via connecting elements to the elements for varying the transmittance and generating an illumination of the crystal;
the control unit comprises at least one event sensor such as a luminosity sensor and/or a temperature sensor;
the transmittance variation element is an electrochromic element, in particular a liquid crystal electrochromic element;
the illumination generation element is a transparent lighting element of the OLED type;
the casing comprises a control unit configured to drive/control/adjust the transmittance variation element so as to dynamically regulate a temperature of the enclosure of said casing;
the casing comprises a control unit configured to drive/control/set the illumination generation element so as to adjust/set the contrast of said watch display interface;
said enclosure is under vacuum or near-vacuum;
the crystal has a surface that is substantially greater or strictly greater than that of a watch case crystal.

### BRIEF DESCRIPTION OF THE FIGURES

Other features and advantages will be clear from the description which follows, in an indicative and non-limiting manner, with reference to the Figure, wherein is shown a cross-sectional view of a schematic representation of the Dewar casing, according to various embodiments of the invention.

### DETAILED DESCRIPTION OF THE INVENTION

The Figure shows a Dewar 1 casing for mechanical and/or functional components 5 of a watch 10. Such a Dewar casing 1 May also be called an “isothermal casing” or a “thermal protection casing”. Such a casing 1 may comprise a bracelet, and then form a Dewar device also referred to as a “thermal protection device” or “watch Dewar device” which may be worn by a user.

Such a casing 1 is able to provide good thermal insulation for mechanical and/or functional components 5 of the watch 10, a case 12 of which must be removably arranged in an enclosure 4 of this casing 1 in order to provide such thermal insulation for these components 5. In other words, this casing 1 is formed in particular by the combination of its functional elements 15 with the case 12 of the watch 10 in order to provide suitable thermal insulation for these mechanical and/or functional components 5. These functional elements 15 of the casing 1 forming this said enclosure 4 comprise a crystal 6, an inner peripheral wall 17 of a middle part 9a and a back 9b of this casing 1. In this configuration, the watch 10 case 12 is arranged in such an enclosure 4 while being kept away from or at a distance from the functional elements of the casing 1 forming this said enclosure 4. Note that this inner peripheral wall 17 of the middle part 9a is also that of said enclosure 4.

This casing 1 comprises a dynamic system 3 for controlling the temperature of its enclosure 4. Such a system 3 helps to regulate the temperature prevailing in this enclosure 4. For this purpose, this system 3 comprises the crystal 6 of the casing 1, which is a transparent crystal 6 with variable opacity, also simply called a variable opacity crystal 6, and a control unit 8 connected to this crystal 6 which is configured to control/manage this opacity.

The case 1 comprises a control unit 8 including an electronic circuit comprising a controller provided with hardware resources, in particular at least one processor cooperating with memory elements as well as data and control address buses, and also an energy accumulator otherwise called a battery. This control unit 8 comprises in its memory elements several algorithms including an algorithm for managing the temperature in the enclosure 4 and the casing 1 and an algorithm for managing the dynamic contrast adjustment of the watch 10 display device. Such algorithms are executed by the processor of this control unit 8, taking account in particular of data from event sensors comprised in the control unit 8 in order to ensure management of the temperature in the enclosure 4 of the casing 1 and also the management of the contrast of this display device. It should be noted that such data may, for example, provide information relating to events detected by these sensors, said events being likely to contribute to/lead to/generate a variation in the temperature in the enclosure 4 of the casing 1 and/or a variation in the ambient brightness prevailing in the environment of the casing 1 and which may disturb/alter the reading of information present on/in the display device. These events may comprise, in a non-limiting and non- exhaustive manner: the detection of a particular level of luminosity in the environment of the casing 1, in particular solar radiation, and/or the detection of a variation in temperature in the enclosure 4 relative to a configurable reference temperature, etc.

In this context, the event sensor comprises in particular and in a non-limiting and non-exhaustive manner:
a luminosity sensor comprising a solar radiation sensor and/or an infrared solar radiation sensor and/or an ultraviolet solar radiation sensor, and/or
a temperature sensor.

It should be noted that each event sensor forms part of the control unit 8 and is connected to the controller of this unit 8. The temperature sensor is located in the enclosure 4 of the casing 1. The brightness sensor is disposed in the casing 1 and in particular in at least one of the functional elements 15 of this casing 1 so as to be exposed to the light coming from the environment outside the casing 1. By way of example, this luminosity sensor can be arranged in the body of the crystal 6 of the casing 1 and/or on an inner face 16 of this crystal 6.

In this casing 1, the control unit 8 comprises a substrate such as a flexible PCB on which its electronic circuit is arranged, with the exception of the luminosity sensor which may be comprised in the crystal 6 or on an inner face 16 of this crystal 6 of the casing 1. In this context, the circuit can be built on this substrate using three-dimensional printing methods or polymer printing methods. It should be noted that this substrate is arranged in the enclosure 4 on one of the functional elements 15 such as the inner face 18 of the back 9b or on the inner peripheral wall 17 of the enclosure 4.

As mentioned above, the control unit 8, and in particular its controller, is linked/connected via a connection element 14a, 14b to the crystal 6 of the casing 1. More specifically, the control unit 8 is linked/connected via these connection elements 14a, 14b to the elements for varying the transmittance 7a and generating an illumination 7b of the crystal 6. Such a crystal 6 comprises the transmittance variation element 7a and the illumination generation element 7b which are arranged in a superimposed manner. In other words, these transmittance variation elements 7a and illumination generation elements 7b are arranged one on top of the other in the crystal 6. These elements 7a, 7b may be in contact or at a distance from each other in this crystal 6. These elements 7a, 7b can be comprised in this crystal 6 by being joined to each other or disjointed. This superposition of the transmittance variation element 7a with the illumination generation element 7b is configured so that the illumination generation element 7b is closest to the watch 10 than the transmittance variation element 7a.

More precisely, in a first variant, the crystal 6 is formed by an assembly comprising successively a layer of transparent material, a stack of functional layers forming said transmittance variation element 7a and a stack of functional layers forming said illumination generation element 7b.

In a second variant, the crystal 6 is formed by an assembly comprising successively an outer layer of transparent material, a stack of functional layers forming said transmittance variation element 7a, a stack of functional layers forming said illumination generation element 7b and an inner layer of transparent material. The outer layer of transparent material corresponds to part of the crystal 6 forming an outer portion of the casing 1. The inner layer of transparent material corresponds to the part of the crystal facing the crystal 11 of the watch 10 case 12 and therefore of the display device.

In a third variant, the crystal 6 is formed by an assembly comprising successively a first outer layer of transparent material, a stack of functional layers forming said transmittance variation element 7a, a second inner layer of transparent material and a stack of functional layers forming said illumination generation element 7b.

It should be noted that the layer of transparent material is made of a glass-like material such as mineral glass, optical ceramics, acrylic glass or sapphire glass.

In this context, the element for varying the transmittance 7a is, for example, an electrochromic element, in particular a liquid crystal electrochromic element. It is recalled that this transmittance is the amount of energy (thermal or light radiation) that the crystal 6 of the casing 1 is capable of transmitting in relation to the flux of incident solar radiation.

Such an element for varying transmittance 7a, when it is an electrochromic element, includes a layer of an electrochromic material capable of reversibly and simultaneously inserting cations and electrons and whose oxidation states corresponding to the inserted and de-inserted states are of distinct colouration, one of the states having a higher light transmission than the other. The insertion or de-insertion reaction is controlled by the application of an electrical voltage by the control unit 8. The electrochromic material, usually based on tungsten oxide, must therefore be contacted with a source of electrons, such as a transparent electrically conductive layer, and a source of cations, such as an ionically conductive electrolyte.

This transmittance variation element 7a is formed, in a manner known per se, from a stack of functional layers. More specifically, in the case of a liquid crystal electrochromic element, this stack of functional layers comprises a film placed between first and second electrically conductive layers and based on a polymeric material wherein droplets of liquid crystals, in particular nematic liquid crystals with positive dielectric anisotropy, are dispersed. When the film is energised, the liquid crystals are oriented along a preferred axis, and configure the crystal 6 in a first state where the transmittance of this crystal 6 is at a maximum. When the film is de-energised, in the absence of alignment of the crystals, the film becomes diffusive and absorbent, and the crystal 6 is then configured in a second state where its transmittance is minimum or even zero.

Alternatively, this stack of functional layers of the transmittance variation element 7a may comprise, for example:
a first electrically conductive layer;
a first layer of anodic electrochromic material made of hydrated iridium oxide (this could be replaced by a layer of hydrated nickel oxide);
a layer of hydrated tantalum oxide with a protective function;
a layer of electrolyte in solid solution of polyoxyethylene with phosphoric acid;
a second layer of cathodic electrochromic material based on tungsten oxide;
a second electrically conductive layer.

It should be noted that the stack of functional layers forming the transmittance variation element 7a may comprise an additional layer of thermoplastic polymer such as polyvinyl butyral known by the acronym PVB, which preferably contains ultraviolet filtering agents. Such a layer may be arranged below or beneath the first electrically conductive layer.

The lighting-generating element 7b, for example, is a transparent lighting element, in particular an organic light-emitting diode lighting element known by the acronym OLED.

Such an OLED-type lighting element includes a stack of transparent functional layers comprising layers of organic electroluminescent materials supplied with electricity by transparent electrodes, generally in the form of first and second electrically conductive layers, of this stack, flanking this/these layer(s) of material(s). Such a lighting element 7b of the OLED type can be designed to emit polychromatic radiation defined at 0° by coordinates (x1, y1) in the CIE XYZ 1931 colorimetric diagram, coordinates therefore given for normal radiation. This transparent lighting element 7b is configured to emit light radiation in the direction of the display device or directed towards the display device.

In a non-limiting and non-exhaustive manner, electroluminescent layers can comprise small molecules, known as SM-OLEDs (Small Molecule Organic Light Emitting Diodes), or polymers, known as PLEDs (Polymer Light Emitting Diodes).

In the different variants mentioned above, the transmittance variation element 7a and the illumination generation element 7b can be arranged/applied/printed/deposited one with the other, or with the layer(s) of transparent material.

In particular, in the first embodiment, the transmittance variation element 7a and the illumination generation element 7b can be arranged/applied/printed/deposited with each other to form an assembly, and then this assembly can be applied/arranged on a lower surface of the layer of transparent material then forming the inner face 16 of this crystal 6.

In this configuration, the control unit 8, by controlling/managing the variation of an electrical voltage applied to the first and second electrically conductive layers of the transmittance variation element 7a, enables the transmittance property of the crystal 6 of the casing 1 to be varied between the first and second transmittance states. It should be recalled that the first state here relates to maximum transmittance of this crystal 6 during which state, this crystal 6 of the casing 1 is then transparent, allowing solar radiation to penetrate the in the enclosure 4 of the latter. The second state relates to a minimum or zero transmittance of the crystal 6, during which state the crystal 6 is completely or partially opaque, preventing/blocking the penetration of at least 99% of the solar radiation into this enclosure 4. In other words, in this second state, solar radiation is no longer transmitted by the crystal 6 into the enclosure 4 of the casing 1.

This control unit 8 is also able to control/manage the variation of an electrical voltage applied to the first and second electrically conductive layers of the illumination generation element 7b in order to vary the illumination/light intensity applied to the display device, and in particular the distribution of the illumination/light intensity on this display device. In this way, the control unit 8 is then able to configure a contrast of the display device which is adapted to the surrounding luminosity, with a view to facilitating reading of this display device and/or providing reading comfort for the user of this Dewar device.

This variation in the lighting generated by the lighting generation element 7b, otherwise called variation in light intensity, takes place between two states. A first state relating to maximum light intensity and a second state relating to zero light intensity.

Moreover, as previously mentioned, the watch 10 case 12 is arranged in the casing 1 while being away from or maintained at a distance 19 or else at a spacing 19 from the inner peripheral wall 17 of the enclosure 4, thanks to the reversible fixing device 13 of the casing 1. In other words, such a fixing device 13 is capable of configuring a spacing 19 between said case 12 and functional elements of the casing 1 forming said enclosure 4. In this configuration, the fixing device 13 helps to reduce or even eliminate any heat conduction between the inner peripheral wall 17 of the middle part 9a (or of the enclosure 4) and/or the back 9b and/or the crystal 6 with the watch 10 case 12, in particular with an outer overall face of this case 12. This outer overall face includes an upper face comprising the crystal 11 of the case 12 of this watch 10, a lower face comprising a back of said case 12 and an outer peripheral wall of a middle part of this case 12.

In this configuration, the fixing device 13 for reversibly fixing the watch 10 case 12 to the inner peripheral wall 17 of the enclosure 4 of the casing 1 May comprise: b connecting members each having first and second ends capable of connecting respectively to the watch 10 case 12 and to the inner peripheral wall 17 of the enclosure 4 of this casing 1. The body of each member has a particular structure which helps to reduce heat loss to the outer environment of the casing 1 of the Dewar device and therefore to ensure a stable internal temperature in the watch 10 case 12, and/or b connecting members configured to ensure magnetic levitation of said watch 10 case 12 in said enclosure 4. Indeed, these connecting members are configured to ensure and maintain a spacing 19 between said case 12 and the functional elements 15 forming said enclosure 4 of the casing 1. Such connecting members help to reduce or even eliminate any heat conduction between the inner peripheral wall 17 of the middle part 9a and/or the back 9b and/or the crystal 11 with the watch 10 case 12, in particular with an outer overall face of this case 12.

Note that the case 12 is comprised in a watch 10, which may be an electronic watch, such as a quartz watch, or a mechanical or electromechanical watch.

The above-mentioned mechanical and/or functional components 5 of the watch 10 include, in a non-limiting and non-exhaustive manner: a horological movement, a display device such as a dial, hands, rings, joints and/or electronic and/or electrical components. It will be noted in particular that such electronic and/or electrical components include, for example, a display device, a processor, a memory, an energy storage component, a motor, an integrated circuit and an electronic oscillator, etc.

In this context, the casing 1 includes the middle part 9a on which a bracelet 9c is mounted so that it can be worn by a user of Dewar device. This casing 1 also includes the aforementioned crystal 6 and back 9b. In this casing 1, it will be noted that the crystal 6 preferably comprises a surface that is substantially greater than or strictly greater than a crystal 11 of the watch 10 case 12. In other words, the inner face 16 of the crystal 6 has a surface that is substantially greater than or strictly greater than or equal to that of an upper face of the crystal 11 of the watch 10.

As seen, the functional elements 15 such as the crystal 6, the middle part 9a and the back 9b of this casing 1 together define the enclosure 4 of this casing 1 which is capable of accommodating the watch 10 case 12. These three elements 15 of the casing 1, namely the middle part 9a, the crystal 6 and the back 9b, may be separate elements which are joined together to construct this enclosure 4. Alternatively, the middle part 9a and the back 9b of the casing 1 May together form a one-piece part, said one-piece part defining an opening opposite the back 9b which is capable of being closed by the crystal 6 in a reversible and hermetically sealed manner. Alternatively, the middle part 9a and the crystal 6 of the watch 10 casing 12 can together form a one-piece part, said one-piece part defining an opening opposite the crystal 6 which can be closed by the back 9b, also reversibly and in a sealed and hermetic manner.

The middle part 9a and the back 9b are preferably made, in a non-limiting and non-exhaustive manner, of a metallic material, glass or thermosetting or thermoplastic polymer resins reinforced with carbon or glass fibres, or else ceramic materials. It should be noted that when the middle part 9a and the back 9b are transparent or semi-transparent, being made of glass for example, the inner peripheral wall 17 of the middle part 9a and the inner face 18 of the back 9b may be coated with a metallic or similar reflective coating, such as a layer of silver for example.

Furthermore, in this casing 1, when the watch 10 case 12 is arranged in the enclosure 4 of the casing 1, the space defined between this case 12 and the inner peripheral wall 17 of the middle part 9a, the back 9b and the crystal 6 is empty or almost empty of material. In other words, the enclosure 4 is under vacuum or near-vacuum.

It is therefore understood that in this configuration, this casing 1 has the same properties and features as a Dewar tube/vessel well known in the prior art. As already mentioned, the properties and features of this casing 1 help to give it good thermal insulation with regard to the extreme temperatures that may prevail in the outer environment wherein such a casing 1 May be located.

In addition, it should be noted that the mechanical and/or functional components 5 of the watch 10 May be non-magnetic and/or that the case 12 of the watch 10 May be made of a material or be covered with a coating enabling these components to be insulated from magnetic fields.

Furthermore, the fixing device 13 helps to position the watch 10 case 12 in this casing 1 so that the crystal 11 of this watch 10 case 12 is arranged facing the crystal 6 of the casing 1 so that the information comprised on the dial and/or the display interface of this watch 10 can be perceived through the transparent crystal 6 of the casing 1 by the user wearing the casing 1.

Thus, such a casing 1 provides the mechanical and/or functional components 5 of the watch 10 with very good thermal insulation from the outer environment, reducing or even preventing heat loss by radiation from the components arranged in the watch 10 case 12 over a long period of time. Thus, when the temperature outside the casing 1 reaches extreme values, the temperature inside the enclosure 4 remains substantially equal to the temperature present in the watch 10 case 12 when it arranged in the casing 1, typically around 20° C. It should be noted that regardless of the temperature conditions prevailing in the environment of the casing 1, the temperature present in the watch 10 case 12 is a temperature which does not hinder the correct operation of the watch 10. This temperature is maintained over a period which is 2 to 18 times longer than the period during which such a watch 10 case 12 would be capable of maintaining the operating temperature of its components when located directly in such an environment where such temperatures prevail, in particular extreme temperatures, that is to say when located outside the casing 1. It is thus conceivable that such a configuration allows to protect the mechanical and/or functional components 5 of the watch 10, as well as helping to ensure that they operate optimally in extreme external temperature conditions.

It goes without saying that the present invention is not limited to the embodiments just described and that various simple modifications and variants may be considered by the person skilled in the art without departing from the scope of the invention as defined by the appended claims.

1. A Dewar casing (1) for mechanical and/or functional components (5) of a watch (10), provided with an enclosure (4) wherein a case (12) of said watch (10) can be removably arranged, a display interface of which is disposed facing a crystal (6) of said casing (1), said casing (1) comprising a reversible fixing device (13) fixing said watch (10) case (12) in said enclosure (4) while keeping it away from functional elements (15) forming said enclosure (4) of this case (2), the crystal (6) of said casing (1) comprising an element for varying the transmittance (7a) of said crystal (6) and an element for generating illumination (7b) directed towards a display interface of said watch (10).

2. The casing (1) according to claim 1, wherein the element (7a) for varying the transmittance and the element (7b) for generating illumination are comprised in said crystal (6), being superimposed.

3. The casing (1) according to claim 1, wherein the crystal (6) is formed by an assembly comprising successively a layer of transparent material, a stack of functional layers forming said transmittance variation element (7a) and a stack of functional layers forming said illumination generation element (7b).

4. The casing (1) according to claim 1, wherein the crystal (6) is formed by an assembly comprising successively an outer layer of transparent material, a stack of functional layers forming said transmittance variation element (7a), a stack of functional layers forming said illumination generation element (7b) and an inner layer of transparent material.

5. The casing (1) according to claim 1, wherein the crystal (6) is formed by an assembly comprising successively a first outer layer of transparent material, a stack of functional layers forming said transmittance variation element (7a), a second outer inner layer of transparent material and a stack of functional layers forming said illumination generation element (7b).

6. The casing (1) according to claim 1, wherein it comprises a control unit (8) connected via connecting elements (14a, 14b) to the elements for varying the transmittance (7a) and generating an illumination (7b) of the crystal (6).

7. The casing (1) according to claim 1, wherein the control unit (8) comprises at least one event sensor such as a luminosity sensor and/or a temperature sensor.

8. The casing (1) according to claim 1, wherein the transmittance variation element (7a) is an electrochromic element, in particular a liquid crystal electrochromic element.

9. The casing (1) according to claim 1, wherein the illumination generation element (7b) is a transparent lighting element of the OLED type.

10. The casing (1) according to claim 1, wherein it comprises a control unit (8) configured to drive/control/adjust the transmittance variation element (7a) so as to dynamically regulate a temperature of the enclosure (4) of said casing (1).

11. The casing (1) according to claim 1, wherein it comprises a control unit (8) configured to drive/control/set the illumination generation element (7b) so as to adjust/set the contrast of said watch display interface (10).

12. The casing (1) according to claim 1, wherein said enclosure (4) is under vacuum or near-vacuum.

13. The casing (1) according to claim 1, wherein the crystal (6) has a surface that is substantially greater than or strictly greater than that of a crystal (11) of the watch (10) case (12).
